(19) United States
(12) Patent Application Publication
(10) Pub. No.: US 2018/0072582 A1
(43) Pub. Date: Mar. 15, 2018

(54) PRODUCTION OF COMPOSITE SPINEL POWDERS IN CORE/SHELL STRUCTURE BY FLAME PYROLYSIS METHOD

(71) Applicant: ANADOLU UNIVERSITESI REKTORLUGU, Eskisehir (TR)

(72) Inventor: Ismail Ozgur OZER, Eskisehir (TR)

(73) Assignee: ANADOLU UNIVERSITESI REKTORLUGU, Eskisehir (TR)

(21) Appl. No.: 15/559,066

(22) PCT Filed: Mar. 18, 2016
(86) PCT No.: PCT/TR2016/000033

§ 371 Date: Sep. 18, 2017

(30) Foreign Application Priority Data
Mar. 18, 2015 (TR) 2015/03254

(51) Int. Cl. C01F 5/06; C01F 7/16; C01F 7/30; C04B 35/443; C04B 35/626; C04B 35/628; C04B 35/632; C09C 1/02; C09C 1/40

(52) U.S. Cl. CPC C01F 5/06; C04B 35/62884; C01F 7/304; C04B 35/443; C04B 35/62665; C04B 35/62813; C04B 35/6325; C09C 1/02; C09C 1/407; C01P 2002/32; C01P 2004/64; C01P 2004/84; C04B 2235/3222; C04B 2235/441; C04B 2235/449; C04B 35/62625; C04B 35/6267; C01F 7/162

(57) ABSTRACT

The present invention relates to a method for the passivation of MgAl₂O₄ (Mg-spinel) powders against hydrolysis exhibiting in aqueous media by coating the surfaces with Al₂O₃ during the synthesis via flame pyrolysis technique. Stable aqueous suspensions with high solid loading and low viscosity can be prepared from coated powders with a core/shell structure of MgO.nAl₂O₃ (0.65<n<4.10)/Al₂O₃. Such suspensions might not only ensure production of high quality granules, but also enable production of green bodies with high density and homogeneity through wet forming methods. Accordingly, precise microstructural control can be ensured during sintering. Al₂O₃ shell re-dissolves within the core during sintering at variable temperatures depending on the core stoichiometry (n value). The final stoichiometry might be altered by controlling the “n” value of the core, the shell thickness and particle size distribution.

### CROSS REFERENCE TO RELATED APPLICATIONS

This application is the national phase entry of International Application No. PCT/TR2016/000033, filed on Mar. 18, 2016, which is based upon and claims priority to Turkey Patent Application No. 2015/03254, filed on Mar. 18, 2015, the entire contents of which are incorporated herein by reference.

### TECHNICAL FIELD

The present invention relates to a method for the passivation of MgAl₂O₄ (Mg-spinel) powders against hydrolysis that they exhibit in aqueous media, by coating the surfaces with Al₂O₃ during the synthesis via flame pyrolysis technique. Although the invention elementarily covers the synthesis of powders using flame pyrolysis method, it further relates to the rheology of the suspensions prepared for advanced Mg-spinel ceramics and, in particular, transparent Mg-spinel ceramics applications, and forming and sintering of ceramic bodies.

### BACKGROUND

Mg-spinel ceramics are important engineering materials used in critical applications such as transparent armor and infrared (IR) dome. High density (relative density—circa 99.99%) to achieve desired optical properties required for such applications is generally obtained through pressure assisted sintering techniques such as hot pressing, hot isostatic pressing, etc. Either for this type of optical applications, or for other advanced engineering applications (such as refractor, dielectric materials) of Mg-spinel produced by conventional powder processing, the objectives intended for improving the production processes has two main focus points. The first one is to improve the physical and chemical properties of the material by ensuring microstructure control during sintering process, and the other is to manufacture products in large sizes and relatively complicated geometries (e.g.; dome) that present identical performance throughout the entire section, economically. As known in the science of ceramics, colloidal processes do not only allow production of products in different geometries and dimensions through wet forming methods, but also ensure more controlled microstructure development throughout the sintering process by allowing more homogenous packing and high grain-grain coordination (low pore-grain coordination) in the green body as compared to the dry methods (such as pressing). Therefore, it is possible to achieve both objectives for improving the Mg-spinel production for advanced engineering applications through colloidal processes.

The colloidal process that would contribute to defect free forming and final microstructural control by achieving homogeneous and well-packed green bodies, necessitates preparation of suspension with high solid loading (e.g.; >55-60 vol. %) and low viscosity (so-called optimum for traditional ceramics). In general, low viscosity is an indication of flock free suspension. The colloidal processes yielding suspensions containing high concentration of flocks where primary particles are not well-dispersed might result in heterogeneous green microstructures similar to the ones formed by employing dry methods. As the nano-sized powders used in production of advanced Mg-spinel (e.g.; transparent Mg-spinel) ceramics present the tendency of agglomeration and flocculation in the suspension due to their large surface areas (circa 15-80 m²/g), they do not allow preparation of suspensions that would propound the aforementioned advantages of the colloidal processes. Such a problem can be eliminated by adjusting the particle size according to the optimization of sintering activity and processability, by modifying the powder synthesis parameters used. However, a more significant problem for Mg-spinel is that the aqueous colloidal system preferred in fabrication process due to its cost-effective and environmentally friendly characteristics leads to hydrolisation of the powder, thus inducing coagulation. Ganesh (Ganesh, I., G. Reddy, J., Sundararajan, G., Olhero, S. M., Torres P. M. C., Ferreira, J. M. F., Ceramics International 2010, 36, 473-482), reported that it is not possible to prepare aqueous Mg-spinel suspensions with solid loadings above 30 vol. % due to hydrolisation problem. On the other hand, Kadosh et al. (Kadosh, T., Cohen, Y., Talmon, Y., Kaplan, W. D., J. Am. Ceram. Soc. 2012, 95 (10), 3103-3108), reported that the aqueous suspensions even with a solid content of 30% contains high amount of flocks, and that such suspensions are not suitable to achieve good green microstructures. In line with the findings of Kadosh et al., the specimens prepared by Zych et al. (Zych, K., Wajler, A. and Lach, R., Mat. Sci. Forum 2013, 730-732, 82-87/Zych, L., Lach, R., Wajler, A., Ceramics International 2014, 40 (7), Part A, 9783-9790) from 30% suspension of commercially available Mg-spinel powders (d₅₀=—about 200 nm) presented poor characteristics in terms of microstructure development when compared to the specimens prepared with dry methods. Zych et al. attributed such outcome to the poor quality of suspension. Ramavath et al. (Ramavath, P., Biswas, P., Rajeswari, K., Suresh, M. B., Johnson, R., Padmanabham, G., Kumbhar, C. S., Chongdar, T. K., Gokhale, N. M., Ceramics International 2014, 40 (4), 5575-5581) reported that they managed to prepare a suspension with higher solid loading (37-39%) by employing the same commercially available powder and a similar process (ammonium polyacrylate dispersant) with Zych et al. The fact that the specimens prepared with the these suspensions fails to present a significant difference in terms of microstructure and properties when compared to the specimens prepared using dry methods indicate that the suspensions prepared are not suitable to achieve proper green bodies. Distinct from these studies, Krell (Krell, A., Klimke, J. and Hutzler, T., J. Euro. Cer. Soc. 2009, 29, 275-281/Krell, A., Hutzler, T., Klimke, J., Potthoff, A., J. Am. Ceram. Soc. 2010, 93 (9), 2656-2666) managed to achieve a more homogeneous and better packed Mg-spinel green microstructures by employing colloidal processes. However, Krell reported that the same process with Al₂O₃ produced a much better result, since Mg-spinel has hydrolisation problem. Ganesh (Ganesh, I., Bull. Mater. Sci. 2011, 34 (2), 327-335), proposed a chemical process for the passivation of Mg-spinel powder surfaces against hydrolysis in order to prepare high quality aqueous suspensions. This process includes addition of ethanol, H₃PO₄ and Al(H₂PO₄)₃ solution to non-aqueous suspension of Mg-spinel, and agitating the final suspension at 80° C. for 24 hours under N₂ flow. At the end of 24 hours filtered powders are washed using ethanol until residual acid is removed, and then it is possible to disperse the powder in distilled water using tetra methyl ammonium hydroxide and polyacrylic acid. Ganesh et al. performed both gel casting and slip casting studies using the powders passivated through mentioned process. They managed to prepare aqueous suspensions at relatively high solid loadings up to 45 vol. % using the passivated powders for those forming methods. However, the reported process is extremely complicated and time-consuming. Moreover, this process is not suitable for processing powders in large quantities.

The studies outlined above reveal that, even with proper particle size, it is not possible to prepare aqueous Mg-spinel suspensions at adequate standards using unprocessed powders due to hydrolysis problem. Since the magnitude of this problem would increase in a scaled-up production where high quantity of suspensions are stored in tanks for prolonged periods, colloidal processes cannot be used effectively in advanced Mg-spinel production processes despite the advantages they provide. Moreover, the passivation technique through chemical method as suggested by Ganesh is complicated, time-consuming and not suitable for processing high volume of powder at industrial scale as underlined before.

### SUMMARY OF THE INVENTION

By virtue of the present invention, Al₂O₃, coated on the flame pyrolyzed Mg-spinel powders during the synthesis process, protects the spinel core against high hydrolisation kinetics, thus enable preparation of highly stable aqueous suspensions with high solid loading (>45 vol. %). The coating can also be applied on pre-synthesized Mg-spinel powders by feeding a non-aqueous (e.g.; alcohol) suspension prepared using such powders, to the reactor.

When the aqueous suspensions of coated powders in MgO.nAl₂O₃ (0.65<n<4.10)/Al₂O₃ core/shell structure are used directly with wet forming methods (e.g.; slip casting), they are capable of enabling production of homogenous, well-packed and high density green bodies with distinct geometries. Therefore, they might have significant contribution to precise microstructure control during sintering process of advanced Mg-spinel ceramics. Homogenous and dense green bodies do not only ensure better final microstructure, and accordingly higher physical and chemical properties, but also reduce the sintering temperature, thus enable more economic production.

Another aim is to use the suspensions of composite powders at core/shell structure in Mg-spinel granule production with spray drier. Goldstein (Goldstein, A., J. Eur. Ceram. Soc. 2012, 32, 2869-2886) reported that the available commercial granules used in production of advanced Mg-spinel ceramics do not have the quality to produce homogenous green bodies. The granule properties are significantly dependent on the colloidal process employed prior to spray drier and associatively to the suspension quality. Therefore, stable suspensions that can be produced with powders of core/shell structure enable production of high quality granules.

Al₂O₃ shell in composite powders protects the Mg-spinel core during the colloidal process, and re-dissolve in the core at variable temperatures (1100-2000° C.) during sintering or heat treatment depending on the stoichiometry (n value). Thus, no residue phase remains within the sintered structure. By virtue of these characteristics of the composite powders in core/shell structure, it is aimed to use them for optical applications (such as transparent armor, IR-dome, IR-detector window), where single phase microstructures are sought in particular. It is well-known that the microstructures of commercially available transparent Mg-spinel products are open to further improvement. For instance, the ceramics used at current transparent Mg-spinel armor systems have microstructures composed of large grains (50-300 micrometers) that exhibit abnormal grain growth, which deteriorates mechanical properties. It is aimed to achieve significant contributions to microstructural control and consequently final properties through homogeneous and highly dense green bodies formed from colloidal processes of core/shell powders.

It is further aimed to ensure that the powders with core/shell structure provide advantages in terms of stability as compared to the conventional Mg-spinel not only at the aqueous systems, but also at the non-aqueous systems. For instance, even in the processes where highly pure alcohols are used, humidity can be dissolved in the solvent media since alcohol and water are miscible liquids. In such medias, the powders with core/shell structure have an advantage in terms of hydrolysis kinetics as compared to the conventional Mg-spinel powders.

### BRIEF DESCRIPTION OF THE DRAWINGS

FIG. 1. The schematic view of the system that is composed of the aerosol nozzle, pilot flame nozzle and the “bubbler” which enables coating via chemical vapor deposition technique.

FIG. 2. The schematic view of the flame pyrolysis unit used for synthesis and coating.

FIG. 3. Plot showing Al₂O₃ shell thickness required to achieve stoichiometric spinel as a function of average particle size and n values of the core structure rich in MgO (MgO.nAl₂O₃, n<1)

FIG. 4. Plot showing the final stoichiometry as a function of coating thickness and average particle size, after the dissolution of Al₂O₃ shell within Mg-spinel core.

FIG. 5. Plot showing the average core size as a function of overall magnesium and aluminum concentration at the precursor solution.

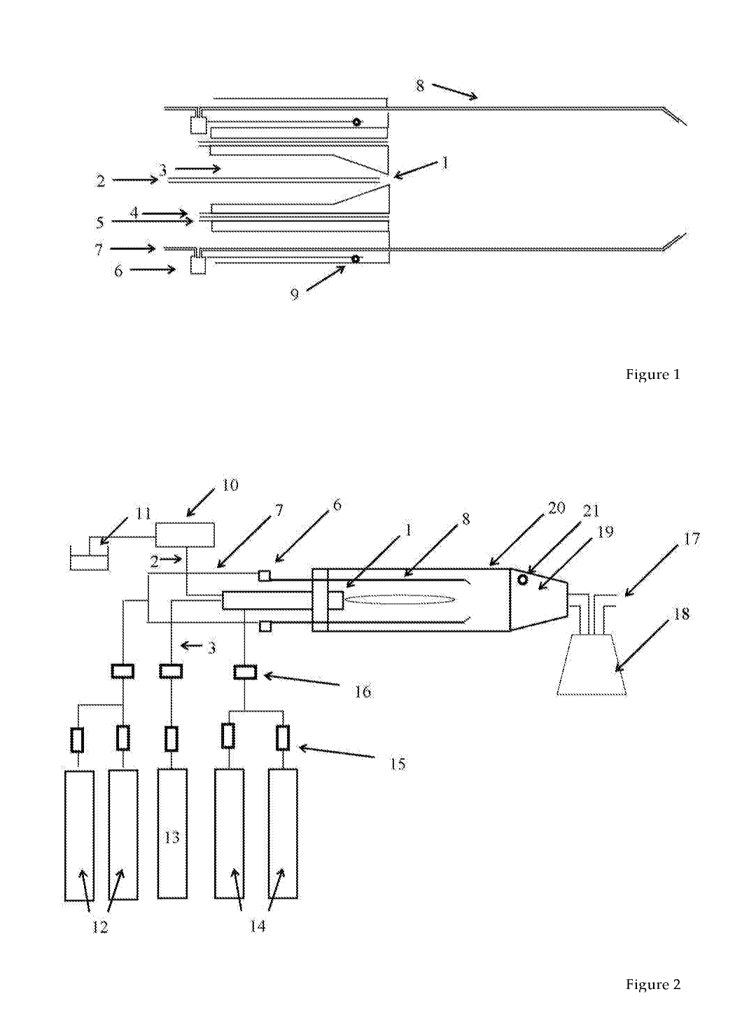

### REFERENCE SIGNS

1: Aerosol nozzle system
2: Solution feeding to the aerosol nozzle
3: Dispersion gas feeding to the aerosol nozzle
4: Pilot flame
5: Screening gas feeding
6: Bubbler system
7: Carrier gas or gases feeding
8: Steel pipe to feed the carrier gas and coating precursor vapor mixtures to the reactor
9: Guide ensuring movement of the bubbler system
10: Peristaltic pump
11: Precursor solution
12: Carrier gas tanks
13: Dispersion gas tank
14: Gas tanks for pilot flame
15: Flow meter
16: Flame arrestor
17: Vacuum
18: Vacuum filter bag
19: Tapered cover to which powder collection unit is connected
20: Fused silica tube
21: Thermocouple hole

### DETAILED DESCRIPTION OF THE INVENTION

The present invention relates to a method for the passivation of MgAl₂O₄ (Mg-spinel) powders against hydrolysis that they exhibit in aqueous media, by coating the surfaces with Al₂O₃ during the synthesis via flame pyrolysis technique. The spinel core of composite powder in MgO.nAl₂O₃ (0.65<n<4.10)/Al₂O₃ structure is synthesized by flame pyrolysis method and coated with Al₂O₃ sequentially in the same reactor. The present invention also enables the coating of pre-synthesized or as-received Mg-spinel powders by feeding a suspension prepared out of these powders into the reaction chamber.

To synthesize the MgAl₂O₄ core by flame pyrolysis method, first of all a precursor solution is prepared, which will be fed into the aerosol nozzle (1) to supply Mg⁺² and Al⁺³ cations to the system. Metal organic compounds of the magnesium, and the metal organic compounds of the aluminum, or salts of these metals are used to prepare the precursor solution. Examples for magnesium source includes magnesium acetylacetonate, magnesium acetylacetonate dihydrate, magnesium ethoxide, magnesium tertbutoxide, magnesium 2-ethylhexagonate, magnesium formate, magnesium formate dihydrate, magnesium myristate, magnesium naphthenate, dihydrogen magnesium ethylenediamintetraacetate, bi(2,2,6,6-tetramethyl-3,5-heptanedionate) magnesium, bi(2,2,6,6-tetramethyl-3,5-heptanedionate) magnesium dihydrate, (bicyclopentadienyl) magnesium (II), bi(ethylcyclopentadienyl) magnesium, bi(methyl-n5-cyclopentadienyl) magnesium, bi(pentamethylcyclopentadienyl) magnesium, magnesium d-gloconathydrate, magnesium monoperoxyphthalate hexahydrate, magnesium trifluoromethanesulphonate, magnesium bi(trifluoromethylsulphonyl)imide, magnesium acetate, magnesium acetate tetrahydrate, magnesium nitrate hexahydrate, magnesium perchlorate. Examples for aluminum source includes aluminum (III) acetylacetonate, aluminum 2-ethylhexagonate, aluminum ethoxide, aluminum isopropoxide, aluminum tertbutoxide, aluminum tributoxide, aluminum trimethoxide, triethanolamine aluminum, aluminum oleate, aluminum (III) secbutoxide, aluminum phenol sulphonate, aluminum chloride, aluminum nitrate hexahydrate, aluminum nitrate nanohydrate. Polar or apolar organic liquids are used as solvents depending on their ability to solve metal organic or salt compounds, and their inflammability. Examples for such solvents include ethanol, methanol, acetic acid, n-butanol, isopropanol, n-propanol, formic acid, hexane, benzene, xylene, toluene, ethyl acetate, tetrahydrofuran, dichloromethane, acetone, and acetonitrile. The Mg:Al ratio at the precursor solution is preferably in the range of 1:1.7-1:2, but can also be prepared in the range of 1:1.3-1:8.2. The range to be selected is closely related to the field of use of the powder and the phase purity to be achieved. For instance, as disclosed hereunder, the studies executed under the scope of the present invention revealed that the range of 1:1.7-1:2 is adequate for powders intended for producing transparent Mg-spinel. Besides, deviating significantly from the values that would ensure stoichiometry (<<1:2<<) leads to formation of secondary phases (e.g.; Al₂O₃ or MgO at different transition phases).

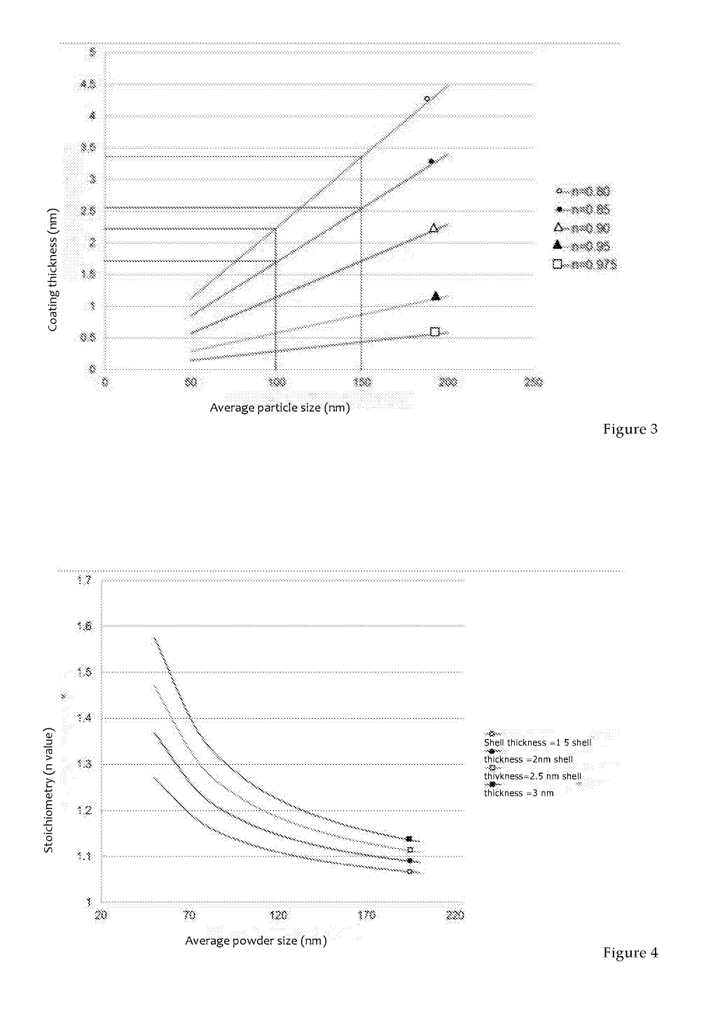

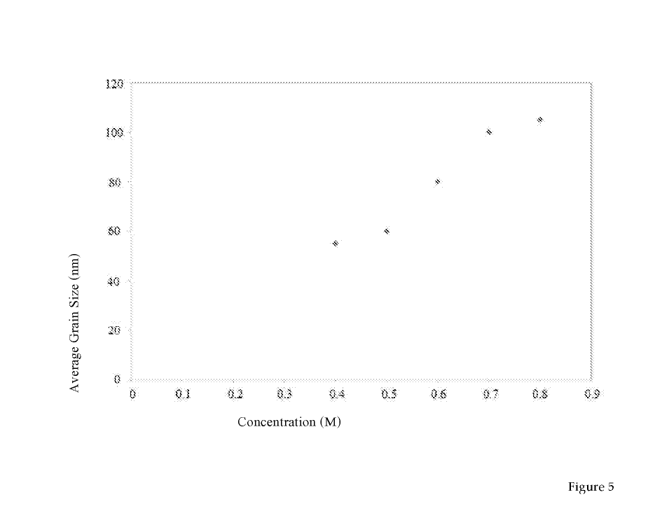

As the powder in core/shell structure synthesized according to the present invention is used for ceramics production, the shell starts to dissolve within the core during sintering at temperatures above approximately 1050° C., thus altering the final stoichiometry. The stoichiometry affects both the sintering behavior of Mg-spinel and the properties of the final product. Sintering kinetics are closely related to the diffusion of O⁻² that controls the densification of Mg-spinel, and thus to the vacancy concentration of O⁻² in the structure. Accordingly, stoichiometry rich in magnesium content that increase the vacancy concentration of O⁻² improve the rate of the sintering. However, although the vacancies of O⁻² in the crystalline structure improve the sintering kinetics, they form color centers (Farbe center) at the system, thus leading to darkening at the transparent product. When an optimization between the sintering kinetics and darkening/light transmission is considered, it is not desirable for the final stoichiometry to shift towards sides excessively rich in magnesium or alumina. The final stoichiometry achieved after sintering can be altered depending on the core stoichiometry, Al₂O₃ shell thickness and phase (in relation to the density of the phase) and finally to the average grain size and size distribution variables of the core/shell powders. The effect of such parameters on the final stoichiometry is presented in FIGS. 3 and 4 for amorphous Al₂O₃ shell. For instance; assuming that the Mg and Al cations in the precursor solution react completely during flame pyrolysis in order to yield Mg-spinel, the Mg:Al ratio in the solution in the range of 1:1.7-1:2 would be expected to give an n value (MgO.nAl₂O₃) in the range of 0.85-1 (Example 1, for n=1), which indicates the core stoichiometry. As seen in FIG. 3, approximately 2 mm thick amorphous Al₂O₃ shell on the powder with an average size of 120 nm enables to achieve stoichiometric Mg-spinel (n=1) after sintering, when the n value of the core is set to 0.85. FIG. 4 shows the change in stoichiometry by the dissolution of the shell in the core, as a function of particle size and shell thickness for a common thickness range achieved. For instance, when the n value indicating the core stoichiometry is 1, the amorphous Al₂O₃ shell at approximately 2 nm thickness obtained for powder with an average size of 100 nm enables to achieve an “n” value of 1.2 after sintering. Therefore, to synthesize core/shell powders for manufacturing transparent Mg-spinel ceramics, Mg:Al ratio in the precursor solution set to a value in the range of 1:1.7-1:2 do not shift the final stoichiometry towards the extreme values for a proper shell thickness and particle size and thus enable to achieve products with high transparency.

The overall magnesium and aluminum concentration at the precursor solution to be fed to the aerosol nozzle (1) is selected in the range of 0.5-1.5 M (Although the Mg:Al ratio is preferentially selected in the range of 1:1.7-1:2 as specified above, it might also be selected in the range of 1:1.3-1:8.2). The beaker containing the solution is placed into, and hold in, the water bath at temperatures varying in the range of 50-65° C. depending on the type of solvent and selected concentration, during the process. The solution is then supplied to the aerosol nozzle (1) by a peristaltic pump (10) at a flow rate in the range of 0.25-50 ml/min., preferably 12.5 ml/min. Solution concentration and flow rate has a significant effect on the size of Mg-spinel core and on residue phase formation. Low agglomeration tendency together with high sintering activity is taken into consideration at the powders produced with the present invention. Therefore, although it is possible to synthesize powder in the range of 10-180 nm in the art, a size range around 100 nm is taken as focus. The effect of the initial concentration on the core size for the system given in Example 1 is presented in FIG. 5 (for a fixed flow rate of 12.5 ml/min.). The core size is assumed to be equal to the size of the coated powder that is measured with dynamic light scattering method (Zeta nanosizer, Malvern, UK) since the coating thicknesses achieved with this method are low (2-10 nm). As illustrated, the core size for the system given in Example 1 increases as a function of precursor solution concentration. The phase purity for all process parameters used are analyzed by XRD. As known, XRD fails to detect the phases under 3% in the system. Therefore, MgO or Al₂O₃ at undetectable low quantities might be present at the systems where phase purity is ensured (Mg:Al being between 1:1.7 and 1:2). Residual Al₂O₃ phases were detected at the system for the study disclosed in Example 1 during different trials when the flow rate reaches up to 20 ml/minute, or when Mg:Al ratio is selected above 1:2 for lower flow rates (<20 ml/minute).

The dispersion gas used for forming aerosol from the precursor solution is preferably O₂, but N₂, O₂/N₂ mixture or dry air are also used. Calibrated mass flow meter (15) are employed to supply the gasses to the flame pyrolysis system at an accurate flow rate and pressure. Dispersion O₂ gas (3) is fed to the system at the range of 1-5 L/min., preferably at the rate of 2.5 L/min.

The pilot flame (4) required for igniting the aerosol is obtained with methane/oxygen mixture. Methane/oxygen ratio of 0.46 that is rich in oxygen is used at each of the processes disclosed in Examples 1-3. The methane and oxygen flow rates are set as 2.5 L/min. and 5.5 L/min., respectively. N₂ is used as the screening gas (5) at the flow rate of 0.8 L/min. in order to isolate the nozzle tip from the flame of precursor solution and to prevent accumulation of product at the nozzle tip. Values of variables that control the particle size and coating thickness such as concentration and flow rate of the precursor solution and the flow rate of dispersion gas are not limited with the specified values herein, as for the flow rates of methane and oxygen used to form pilot flame and nitrogen used to form screening gas. The values that would form a stable flame ensuring a laminar flow are used against variable process parameters.

The coating precursor vapor to coat MgO.nAl₂O₃ (0.65<n<4.10) cores is supplied to various temperature zones between the flame end and powder collection unit by employing one or more carrying gasses (7). Depending on the desired coating phase and thickness, the gas mixture is supplied to the temperature zones varying in the range of 200-1300° C. Position of the steel pipe (8) that transports the carrier gas and acetonate vapor mixture is adjusted according to the temperature profile data of the system obtained prior to the studies. The temperature profiles are obtained separately for each condition (solvent type and feeding rate, gases and feeding rate) studied. The measurements are done by a thermocouple inserted from the hole (21) on the tapered cover (19), at different points between the flame end and end of fused quartz tube. Measurements are done at the thermal equilibrium, after 20 minutes of igniting the solvent used for the synthesis of core particles, without performing powder synthesis and coating. The coating temperature, coating precursor and the carrier gas has a significant effect on the coating phase. The coating might be amorphous, or in a transition phase, or in the stable-phase depending on such parameters. For instance, an amorphous alumina layer of approximately 2 nm thickness is aimed with the coating applied at the range of 300-550° C. (Example 1; 400° C.) using aluminum acetate and dry air. The coating applied at a higher temperature range such as 650-900° C. using aluminum chloride and CO₂/H₂, on the other hand, aims gamma-Al₂O₃ phase (Example 2). When coating precursor vapor is supplied directly to the flame zone, Al₂O₃ homogenously nucleates as alpha-phase instead of nucleating on the core particles, heterogeneously. Metal organic compunds that include groups such as metal alkoxides, alkyls, metal-diketones, or aluminum salts are used as Al₂O₃ coating precursors. The examples for metal organic aluminum constituents used in the invention include aluminum ethoxide, aluminum s-butoxide, aluminum isopropoxide, dimethyl aluminum isopropoxide, dimethyl aluminum isopropoxide, triethylaluminum, triethyl(tri-sec-butoxy) dialuminum, trimethylaluminum, aluminum acetate, aluminum acetylacetonate, aluminum hexafluoraacetylacetonate, tri(2,2,6,6,-tetramethyl-3,5-heptanedionate) aluminum. Examples for the aluminum salts used in the invention include aluminum chloride and aluminum nitrate and the hydrates thereof. The precursor vapor for coating are obtained from mentioned constituents by means of evaporation, sublimation or purging with carrier gas depending on the phase of the aluminum source using a cylindrical “bubbler” (frequently used for chemical vapor deposition processes) (6). A bubbler (6) with thermostat is used in order to carry the identical amount of gas mixture to the system at every turn. Dry air, N₂, O₂ and a mixture of CO₂/H₂ are used as carrier gas (7). Flow rate of carrier gas is adjusted in the range of 0.1 L/min. to 1 L/min. in order to control the coating thickness and to ensure the heterogeneous nucleation conditions of Al₂O₃ at the concerning temperature zone. As disclosed in Example 2, when CO₂/H₂ gas mixture is used, the flow rates of both gasses are equated. Steel pipes (8) that transfer the carrier gas and coating precursor vapor are not preheated against any possible condensation, as they are located in the hot reaction zone.

The powders in MgO.nAl₂O₃ (0.65<n<4.10)/Al₂O₃ core/shell structure obtained at the end of the coating process are then collected in a filter bag unit (17,18) via vacuuming.

As mentioned before, the present invention also enables the coating of pre-synthesized or commercially available Mg-spinel powders by feeding a suspension of these powders into the flame pyrolysis reactor. When commercially available MgAl₂O₄ powders are used, non-aqueous suspensions with low solid loadings in the range of 10 vol. % to 20 vol. %, are prepared in the presence of a dispersant or without using any dispersant, as disclosed in Example 3. The average particle size is selected in the range of 50-1000 nm. Highly pure ethyl alcohol, methyl alcohol, methyl ethyl ketone, n-propanol, isopropanol, n-butanol, formic acid, toluene, pentane, xylene, benzene, hexane, ethyl acetate or mixtures thereof are used as dispersion medium. Phosphate ester or fish oil in the range of 0.5-10 mg/m² depending on the surface area of the powder is used as dispersant. The suspension prepared is supplied to the nozzle (1) at a flow rate that varies in the range of 1-10 ml/min. depending on the solid loading. The type and flow rate of dispersion gas, pilot flame gasses and screening gas are same as described above when suspension is used instead of solution. Likewise, Al₂O₃ coating method is also as disclosed above.

The behavior of the powders in MgO.nAl₂O₃ (0.65<n<4.10)/Al₂O₃ core/shell structure in the aqueous system is studied with zeta potentiometer (Zeta nanosizer, Malvern, UK) and compared with the behavior of the uncoated Mg-spinel powders synthesized with the flame pyrolysis method. No stable zeta measurement can be performed at the uncoated powders. The pH value measured at uncoated Mg-spinel suspensions with low solid concentration (<2% by volume) increases with time. The zeta potential measurements of MgO.nAl₂O₃ (0.65<n<4.10)/Al₂O₃ core/shell structure, on the other hand, indicated that the isoelectric point is 9.2 and that the surface is charged positively against decreasing pH (potential measured at approximately pH 4 is 52 mV), while the surface is charged negatively against increasing pH (potential measured at approximately pH 10 is −22 mV) (Example 1). It is observed that the zeta potential behavior of the powders in core/shell structure against pH is close to the behavior of Al₂O₃ powders. It was possible to prepare highly stable aqueous suspensions of these powders with 48 vol. % by using 0.6 wt. % ammonium polymetacrylic acid as dispersant.

### DETAILED DESCRIPTION OF THE INVENTION

### EXAMPLE 1

In order to prepare the precursor solution, xylene/ethyl acetate mixture at 3:1 ratio by volume is used as solvent, and magnesium acetylacetonate (C₁₀H₁₄MgO₄) and aluminum isopropoxide (C₉H₂₁O₃Al) is used as solute. 51.92 g. magnesium acetylacetonate and 95.32 g. aluminum isopropoxide is placed inside a 1 L beaker in such manner to have Mg:Al ratio of 1:2 at the system and the beaker is filled with xylene/ethyl acetate mixture to have a total volume of 1 L. The solution is then mixed in a vessel with a small opening to prevent pressure formation, for 4 hours at a temperature of 58° C. prior to feeding into the flame pyrolysis system, and the evaporated solvent volume is replenished at the end of the process. The solvent is maintained again at the temperature of 58° C. during the entire flame pyrolysis process.

The precursor solution so prepared is then supplied to the nozzle (1) at a flow rate of 12.5 ml/min. O₂ gas (3) at a flow rate of 2.5 L/min. is used as dispersion gas and N₂ gas (5) at a flow rate of 0.8 L/min. is used as screening gas. Pilot flame is ignited using methane/oxygen gas mixture (4). Methane flow rate is set as 2.5 L/min. and the oxygen flow rate is set as 5.5 L/min.

Aluminum acetyl acetonate is used as aluminum source for coating the synthesized core powder. It is placed in a stainless steel “bubbler” (6) and sublimated at 150° C. Aluminum acetyl acetonate vapor is transferred to the system by using dry air. Dry air flow rate is set to 0.25 L/min. The carrier gas and acetonate vapor mixture (8) is supplied to a zone after the flame end, to a temperature of approximately 400° C.

The average particle size of the powder measured with the dynamic light scattering method (Zeta nanosizer, Malvern, UK) is 100 nm. The zeta potential (Zeta nanosizer, Malvern, UK) measurements of the powders in MgO.nAl₂O₃ (0.65<n<4.10)/Al₂O₃ core/shell structure, indicated that the isoelectric point is 9.2 and that the surface is charged positively against decreasing pH (potential measured at approximately pH 4 is 52 mV), while the surface is charged negatively against increasing pH (potential measured at approximately pH 10 is −22 mV). No stable zeta measurements could be performed with the uncoated Mg-spinel powders produced with the processes disclosed above. It was observed that the pH of dilute aqueous suspensions (<2 vol. %) prepared with the uncoated powders varies with time. In addition, coated and uncoated powders exhibit different behaviors at high solid loadings. It was possible to prepare aqueous suspensions of coated powders with 48 vol. % solid loading by using 0.6 wt. % ammonium polymetacrylic acid as dispersant. However, only 27 vol. % of solid loading could be achieved with uncoated powders.

### EXAMPLE 2

The precursor used to synthesize Mg-spinel core structure, the ratios of such chemicals, the flow rate of the precursor solution, the dispersion gas, the screening gas, the gasses that form the pilot flame and the flow rates of such gasses are identical to the ones set forth in Example 1. Example 2 differs from Example 1 only in terms of the coating method of the Al₂O₃ shell.

Aluminum chloride (AlCl₃) is used as aluminum source for coating the synthesized core powder. Aluminum chloride is placed inside a stainless steel “bubbler” (6) and the temperature is maintained fixed at 200° C. Aluminum chloride vapor is transferred to the system using CO₂/H₂ mixture. The flow rate for both gasses is set as 0.15 L/min. The gas mixture (8) is supplied to a zone after the flame's end at a temperature of approximately 750° C. Differing from Example 1, a water trap is used before vacuuming (17) in order to prevent release of gasses used and the HCl vapor generated as a result of the reactions depending on such gasses to the environment.

The average coated particle size measured with the dynamic light scattering method (Zeta nanosizer, Malvern, UK) is 110 nm. The zeta potential measurements of composite powders in core/shell structure indicated that the isoelectric point is 8.7 and that the surface is charged positively against decreasing pH (potential measured at approximately pH 4 is 48 mV), while it is charged negatively against increasing pH (potential measured at approximately pH 10 is −24 mV). No stable zeta measurements could be performed with the uncoated Mg-spinel powders synthesized as disclosed in Example 1.

### EXAMPLE 3

Commercially available MgAl₂O₄ powder (S30CR, Baikowski, France) is dispersed in toluene:ethyl alcohol mixture (1:1) by 10 vol. %, using 0.5 wt. % phosphate ester as dispersant. 1.07 g. phosphate ester was dissolved in 270 ml toluene and 270 ml highly pure ethyl alcohol mixture. Then, 214.68 g MgAl₂O₄ powder is added to the beaker. In the course of addition, the suspension was agitated using a magnetic stirrer and at the same time, the agglomerates were crushed using an ultrasonic horn. Despite its low solid loading, the suspension was constantly agitated against precipitation for the duration of its supply into the flame pyrolysis unit. The suspension is then fed to the nozzle (1) at a flow rate of 2 ml/min. O₂ gas (3) at a flow rate of 2.5 L/min. is used as dispersion gas and N₂ gas (5) at a flow rate of 0.8 L/min. is used as screening gas. Pilot flame is ignited using methane/oxygen gas mixture (4). Methane flow rate is set as 2.5 L/min. and the oxygen flow rate is set as 5.5 L/min.

Aluminum acetyl acetonate is used as aluminum source for coating the commercial MgAl₂O₄ powder. Aluminum acetyl acetonate is placed inside a stainless steel “bubbler” (6) and sublimation of the precursor is ensured by maintaining the temperature fixed at 150° C. Aluminum acetyl acetonate vapor is transferred to the system using dry air. Dry air flow rate is set as 0.25 L/min. The carrier gas and acetonate vapor mixture (8) is supplied to a zone after the flame's end at a temperature of approximately 400° C.

The zeta potential measurements of the coated powder showed an isoelectric point of 9.5. As disclosed in Example 1, the powders in core/shell structure achieved with this method enabled preparation of stable aqueous suspensions at high solid loading by using ammonium polymetacrylic acid as dispersant. As received commercial MgAl2O4 powder did not allow preparing concentrated suspensions. This embodiment where commercial MgAl2O4 powder is coated enables preparation of stable aqueous suspensions with 45 vol. % solid loading. When the commercial MgAl2O4 powder is used directly, on the other hand, the suspensions with solid loading above 25 vol. % become coagulated.

What is claimed is:

1˜31. (canceled)

32. A Method for preparation of magnesium spinel cores, comprising
feeding a magnesium spinel source to an aerosol nozzle of a flame pyrolysis reactor to form a plurality of magnesium spinel cores, wherein the aerosol nozzle has a tip;
the method further includes alumina coating of the plurality of magnesium spinel cores obtained from the aerosol nozzle by supplying of vapor of an alumina coating precursor to a zone between a flame end and a powder collection unit of the flame pyrolysis reactor along with one or more carrying gases; wherein the zone is at a temperature within the range between 200° C. and 1300° C.; and,
wherein the magnesium spinel source comprises a non-aqueous suspension including a dispersion medium and an amount of magnesium spinel within the range between 10% (v/v) and 20% (v/v) with respect to a total volume of the suspension, wherein an average particle size of magnesium spinel in the suspension is within the range between 50 nm and 1000 nm; or
the magnesium spinel source comprises a magnesium spinel precursor solution of metal organic compounds or salts of magnesium and aluminium, wherein the precursor solution includes Mg²⁺ and Al³⁺ cations; wherein the magnesium spinel precursor solution further comprises an organic liquid as solvent, wherein the Mg:Al stoichiometric ratio in the magnesium spinel precursor solution is within the range between 1:1.3 and 1:8.2; wherein the overall magnesium and aluminium concentration is within the range between 0.5 M and 1.5 M.

33. The method according to claim 32, wherein the alumina coating precursor comprises an aluminium salt, or a metal organic compound selected from the group consisting of metal alkoxides, metal alkyls, and metal diketones.

34. The method according to claim 33, wherein the metal organic compound is one or more selected from the group consisting of aluminium ethoxide, aluminium s-butoxide, aluminium isopropoxide, dimethyl aluminium isopropoxide, triethyl aluminium, triethyl (tri-sec-butoxy) dialuminium, trimethyl aluminium, aluminium acetate, aluminium acetylacetonate, aluminium hexafluoro acetyl acetonate, and tri(2,2,6,6,-tetramethyl-3,5-heptanedionate) aluminium.

35. The method according to claim 33, wherein the aluminium salt is one or more selected from the group consisting of aluminium chloride, aluminium nitrate, and hydrates thereof.

36. The method according to claim 32, wherein the alumina coating precursor vapor is obtained through evaporation or sublimation of the alumina coating precursor or purging of the alumina coating precursor with a carrier gas using a cylindrical bubbler; wherein the carrier gas is selected from nitrogen, oxygen, dry air and CO₂/H₂ mixture.

37. The method according to claim 32, wherein the alumina coated magnesium spinel is prepared from magnesium spinel powder as magnesium spinel cores; comprising:
feeding the non-aqueous suspension including the dispersion medium and an amount of magnesium spinel, as the magnesium spinel source, to the aerosol nozzle of the flame pyrolysis reactor at a flow rate within the range of 1 mL/min and 10 mL/min.

38. The method according to claim 37, wherein the dispersion medium is one or more selected from the group consisting of high pure ethyl alcohol, methyl alcohol, methyl ethyl ketone, n-propanol, isopropanol, n-butanol, formic acid, toluene, pentane, xylene, benzene, hexane and ethyl acetate.

39. The method according to claim 32, wherein the method further including synthesis of magnesium spinel cores using the flame pyrolysis reactor, including the steps of:
i. preparing a magnesium spinel precursor solution of metal organic compounds or salts of magnesium and aluminium;
ii. keeping the precursor solution at a temperature within the range of 50° C. and 65° C.;
iii. feeding of the precursor solution as magnesium spinel source into the aerosol nozzle, at a volumetric flow rate within the range of 0.25 mL/min and 50 mL/min.; and mixing the precursor solution with a dispersion gas to form an aerosol;
iv. igniting of the aerosol using a flammable gas mixture to form core particles from vapors of the precursor solution.

40. The method according to claim 39, wherein the molar ratio of Mg:Al in the precursor solution is within the range of 1:1.7 and 1:2.

41. The method according to the claim 39, wherein the volumetric flow rate is 12.5 mL/min.

42. The method according to the claim 39, wherein the dispersion gas is fed into the aerosol nozzle at a volumetric flow rate within the range of 1 liters/min and 5 liters/min.

43. The method according to the claim 39, wherein the ignition of the aerosol is performed using a pilot flame obtained using a methane/oxygen mixture, wherein an amount of oxygen in the mixture is greater than that of methane.

44. The method according to the claim 39, wherein the tip of the aerosol nozzle is isolated from the flame of the precursor solution for prevention of product accumulation, wherein N₂ is used as a screening gas fed to the aerosol nozzle.

45. The method according to the claim 39, wherein the ignition is performed using a pilot flame obtained from a gas mixture provided in a laminar flow.

46. An alumina coated magnesium spinel powder, wherein the alumina coated magnesium spinel powder is obtained through a method comprising synthesis of magnesium spinel cores using the flame pyrolysis reactor, including the steps of:
i. preparing a magnesium spinel precursor solution of metal organic compounds or salts of magnesium and aluminium, wherein the precursor solution includes Mg²⁺ and Al³⁺ cations; wherein the precursor solution further comprises one or more organic liquid as solvent; wherein the molar ratio of Mg:Al in the precursor solution being within the range of 1:1.3 and 1:8.2; wherein the overall magnesium and aluminium concentration being within the range of 0.5 M and 1.5 M;
ii. keeping the precursor solution at a temperature within the range of 50° C. and 65° C.;
iii. feeding of the precursor solution as magnesium spinel source into the aerosol nozzle, at a volumetric flow rate within the range of 0.25 mL/min and 50 mL/min.; and mixing the precursor solution with a dispersion gas to form an aerosol;
iv. igniting of the aerosol using a flammable gas mixture to form core particles from vapors of the precursor solution.
